(19) United States
(12) Patent Application Publication
(10) Pub. No.: US 2013/0343098 A1
(43) Pub. Date: Dec. 26, 2013

(54) Power Converters And Methods For Active Leakage Energy Recovery In A Power Converter

(71) Applicants: Gregory Allen Kern, Redwood City, CA (US); Tilak Gopalarathnam, Fremont, CA (US)

(72) Inventors: Gregory Allen Kern, Redwood City, CA (US); Tilak Gopalarathnam, Fremont, CA (US)

(73) Assignee: SUNEDISON, LLC, Beltsville, MD (US)

(21) Appl. No.: 13/529,519

(22) Filed: Jun. 21, 2012

(51) Int. Cl. H02M 3/335

(52) U.S. Cl. 363/21.12

(57) ABSTRACT

Power converters and methods of recovering leakage energy in power converters are disclosed. In one embodiment, a power converter assembly includes an input for receiving a direct current (DC) power input, a flyback converter coupled to the input, and a leakage energy recovery circuit coupled to the flyback converter. The flyback converter includes a transformer having a plurality of windings. The leakage energy recovery circuit is configured to couple leakage energy from the transformer to the input in response to a voltage across at least one of the plurality of windings

### FIELD

This disclosure generally relates to power converters and, more specifically, power converters including active leakage energy recovery.

### BACKGROUND

Solar panels, also referred to herein as photovoltaic (PV) modules, generally output direct current (DC) electrical power. To properly couple such solar panels to an electrical grid, or otherwise provide alternating current (AC) power, the electrical power received from the solar panels is converted from DC to AC power. At least some known solar power systems use a single stage or a two-stage power converter to convert DC power to AC power. Some systems are controlled by a control system to maximize the power received from the solar panels and to convert the received DC power into AC power that complies with utility grid requirements.

However, at least some known solar power converters are relatively inefficient and/or unreliable. It is desirable for a solar power converter to operate at relatively high efficiency to capture as much energy from a PV module as possible. At least some solar power converters utilize an isolated DC/DC converter including a transformer. One of the loss factors in such converters is the energy loss associated with the leakage inductance of the converter's transformer. In some converters, the losses are proportional to the leakage inductance of the transformer. A greater leakage inductance leads to greater losses and, accordingly, to a lower total conversion efficiency. Some known designs attempt to recover the energy stored in the leakage inductance. These recovery mechanisms, however, are generally not satisfactory.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of the present disclosure is a power converter assembly. The assembly includes an input for receiving a direct current (DC) power input, a flyback converter coupled to the input, and a leakage energy recovery circuit coupled to the flyback converter. The flyback converter includes a transformer having a plurality of windings. The leakage energy recovery circuit is configured to couple leakage energy from the transformer to the input in response to a voltage across at least one of the plurality of windings

Another aspect of the present disclosure is a photovoltaic (PV) power system. The PV power system includes a first converter configured to receive a direct current (DC) power input and provide a substantially DC power output. The first converter includes an input for receiving the DC power input, a flyback converter coupled to the input, and a leakage energy recovery circuit. The flyback converter includes a transformer having a primary winding, a secondary winding, and an auxiliary winding. The leakage energy recovery circuit includes a clamp circuit coupled to the primary winding of the transformer, and an auxiliary converter coupled to the auxiliary winding, the clamp circuit, and the input. The clamp circuit is configured to store leakage energy from the transformer. The auxiliary converter is configured to couple leakage energy from the clamp circuit to the input in response to a voltage across the auxiliary winding.

Yet another aspect of the present disclosure is a method of recovering transformer leakage energy in a power converter. The method includes storing transformer leakage energy in a clamp circuit, and selectively coupling the stored transformer leakage energy to an input of the power converter based on a voltage across an auxiliary winding of the transformer.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic block diagram of an embodiment of a power conversion system.

FIG. 2 is a schematic diagram of a converter for use in the system shown in FIG. 1.

Like reference symbols in the various drawings indicate like elements.

### DETAILED DESCRIPTION

The embodiments described herein generally relate to power converters. More specifically, embodiments described herein relate to power converters including active leakage energy recovery circuits. Moreover, some embodiments described herein relate to power converters and methods of operating power converters for use with a photovoltaic (PV) power source.

Although described herein with reference to power converters for use with a PV source, the teachings of this disclosure may be utilized in power converters for any suitable use.

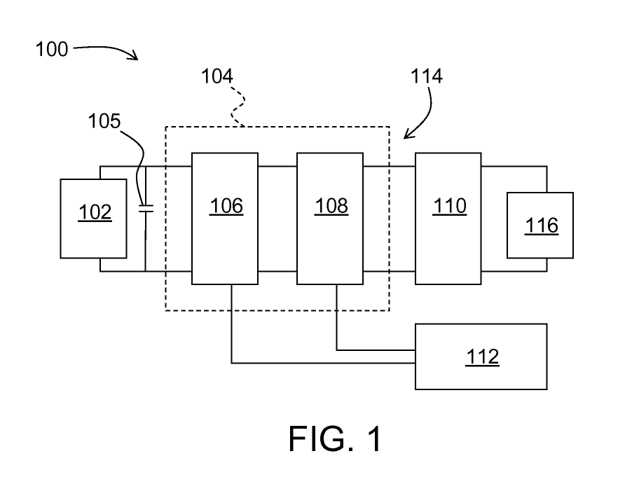

FIG. 1 is a schematic block diagram of this power conversion system 100. A power source 102 is coupled to power conversion system 100 to supply electrical current to system 100. In this embodiment, power source 102 is a photovoltaic or “solar” array that includes at least one photovoltaic panel. Alternatively or additionally, power source 102 includes at least one fuel cell, a direct current (DC) generator, and/or any other electric power source that enables power conversion system 100 to function as described herein.

In this embodiment, power conversion system 100 includes a power converter 104 (sometimes referred to herein as a power converter assembly) to convert DC power received from power source 102, via an input capacitor 105, to an alternating current (AC) output. In other embodiments, power converter 104 may output DC power. This power converter 104 is a two stage power converter including a first stage 106 and a second stage 108. First stage 106 is a DC to DC power converter that receives a DC power input from power source 102 and outputs DC power to second stage 108. Second stage 108 is a DC to AC power converter (sometimes referred to as an inverter) that converts DC power received from first stage 106 to an AC power output. In other embodiments, power converter 104 may include more or fewer stages. More particularly, in some embodiments power converter 104 includes only second stage 108.

Power conversion system 100 also includes a filter 110, and a control system 112 that controls the operation of first stage 106 and second stage 108. An output 114 of power converter 104 is coupled to filter 110. In this embodiment, filter 110 is coupled to an electrical distribution network 116, such as a power grid of a utility company. Accordingly, power converter 104 may be referred to as a grid tied inverter. In other embodiments, power converter 104 may be coupled to any other suitable load.

During operation, power source 102 generates a substantially direct current (DC), and a DC voltage is generated across input capacitor 105. The DC voltage and current are supplied to power converter 104. In this embodiment, control system 112 controls first stage 106 to convert the DC voltage and current to a substantially rectified DC voltage and current. The DC voltage and current output by first stage 106 may have different characteristics than the DC voltage and current received by first stage 106. For example, the magnitude of the voltage and/or current may be different. Moreover, in this embodiment, first stage 106 is an isolated converter, which operates, among other things, to isolate power source 102 from the remainder of power conversion system 100 and electrical distribution network 116. More specifically, in this embodiment, first stage 106 is a flyback converter. The DC voltage and current output by first stage 106 are input to second stage 108, and control system 112 controls second stage 108 to produce AC voltage and current, and to adjust frequency, phase, amplitude, and/or any other characteristic of the AC voltage and current to match the electrical distribution network 116 characteristics. The adjusted AC voltage and current are transmitted to filter 110 for removing one or more undesired characteristics from the AC voltage and current, such as undesired frequency components and/or undesired voltage and/or current ripples. The filtered AC voltage and current are then supplied to electrical distribution network 116.

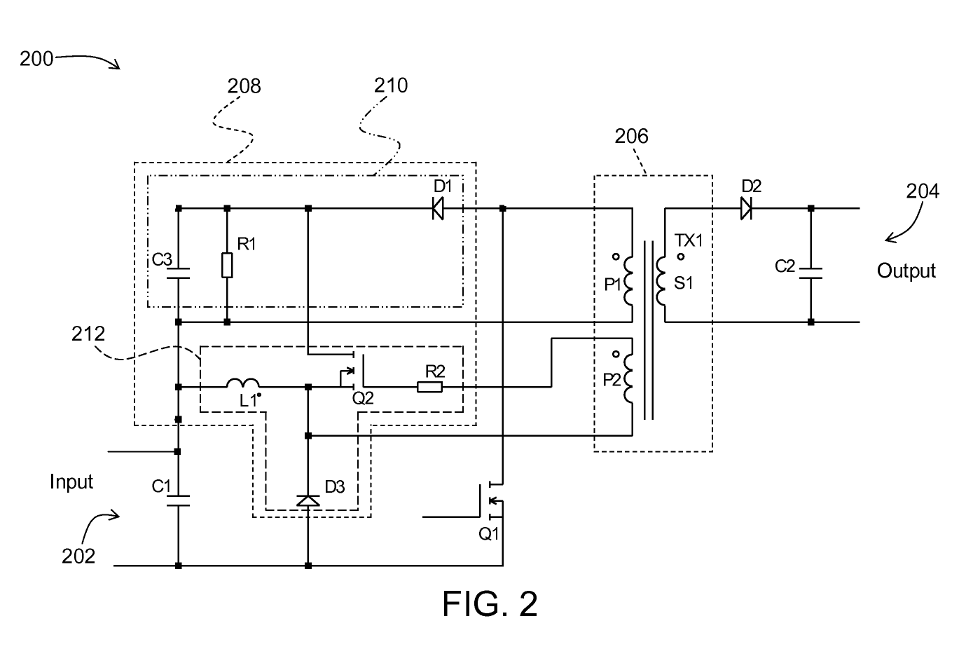

FIG. 2 is a simplified schematic diagram of a converter 200 for use as first stage 106. Converter 200 is an isolated converter. More specifically, converter 200 is a flyback converter. In other embodiments, converter 200 may include multiple converters, including a plurality of interleaved flyback converters. The flyback converter portion of converter 200 generally includes an input capacitor C1, a switch Q1 (sometimes referred to as a flyback switch or a main switch), a transformer 206, a diode D2, and an output capacitor C2. Converter 200 is operable to receive DC power at an input 202 and output DC power at an output 204. In this embodiment, converter 200 is operated by control system 112 to output DC power to electrical second stage 108. Generally, the peak output voltage of converter 200 is greater than the input voltage to converter 200.

Converter 200 includes transformer 206 having a primary winding P1, a secondary winding S1, and an auxiliary winding P2. Primary, secondary, and auxiliary windings P1, S1, P2 are magnetically coupled together, but electrically isolated from each other. Primary winding P1 is connected to input 202 and to main switch Q1. In this embodiment, switch Q1 is a MOSFET. In other embodiments, switch Q1 may be any other suitable switch.

Converter 200 is generally operated as a flyback converter as known in the art. In general, switch Q1 is switched on and off to store and release energy in transformer 206. More specifically, when switch Q1 is closed (also referred to as switched on), current flows through primary winding P1 and energy is stored in the core (not shown in FIG. 2) of transformer 206. When switch Q1 is opened (also referred to as switched off), current ceases flowing through primary winding P1. Current flow is induced in secondary winding S1, releasing the energy stored in the core of transformer 206 to the output 204. The output of transformer 206, and more specifically the output of secondary winding S1, is rectified by a diode D2. Thus, DC output power is provided at output 204 of converter 200.

In general, the leakage inductance of transformer 206 potentially results in a power loss described by:

Ple=½Fs*Le*Ipk2 [1]

Where “Ple” is the leakage energy that may be lost due to leakage inductance, “Fs” is the switching frequency of converter 200, “Le” is the leakage inductance of transformer 206, and “Ipk” is the peak current through the switch Q1 when it turns off.

Converter 200 includes a leakage energy recovery circuit (LERC) 208 configured to recover leakage energy to reduce losses due to leakage inductance. LERC 208 includes a clamp circuit 210, also known as an RCD snubber, and a converter circuit 212 (also sometimes referred to as an auxiliary converter). Generally, the leakage energy from transformer 206 is transferred to clamp circuit 210 when Q1 turns off to clamp the leakage energy to a voltage below the breakdown voltage of switch Q1. More specifically, the leakage energy is transferred to capacitor C3 through diode D1. In some known clamp circuits, the leakage energy is dissipated across a resistor, such as resistor R1. In converter 200, resistor R1 is not used to dissipate all of the leakage energy and may be sized to handle less power than resistors in some known clamp circuits. Moreover, in some embodiments, LERC 208 does not include resistor R1.

During operation of converter 200, capacitor C3 experiences relatively large current pulses from the leakage energy. By so connecting capacitor C3 to capacitor C1, rather than connecting capacitor C3 to ground, the voltage stress of capacitor C3 is reduced and a capacitor with a lower voltage rating may be used. In other embodiments, capacitor C3 may be connected to ground.

Converter circuit 212 is a buck converter comprising switch Q2, inductor L1, and diode D3. In other embodiments, converter circuit 212 may be any other suitable converter topology. In this embodiment, switch Q2 is a MOSFET. In other embodiments, switch Q2 may be any other suitable switch. Converter circuit 212 transfers energy from clamp circuit 210, and more specifically from clamp capacitor C3, to input 202. Transfer of energy from clamp circuit 210 to input 202 is controlled by switch Q2. When switch Q2 is conducting (also referred to as being switched on), energy from capacitor C3 is coupled to input 202. More specifically, switch Q2 couples the leakage energy stored in capacitor C3 to input capacitor C1 through inductor L1.

Control of switch Q2 (i.e., turning switch Q2 on and off) is achieved through auxiliary winding P2 on transformer 206. Switch Q2 couples leakage energy from clamp circuit 210 to input 202 in response to a voltage across auxiliary winding P2. Auxiliary winding P2 is coupled to the gate and source of switch Q2. In operation, when switch Q1 turns off, auxiliary winding P2 applies a voltage to switch Q2. The number of turns on auxiliary winding P2 is sufficient to substantially match the turn on voltage limits on the gate of Q2. Thus, when switch Q1 turns off, switch Q2 turns on. Gate resistor R2 aids in controlling the gate waveform of switch Q2.

In this embodiment, converter 200 is operated in a quasi-resonant or boundary conduction mode. In other embodiments, converter 200 is operated in any other suitable mode including, for example continuous conduction mode, discontinuous conduction mode, etc. In quasi-resonant mode, the flux in the flyback transformer 206 resets to zero at the end of every switching cycle. Accordingly, energy in transformer 206 does not accumulate as it could in some other modes of operation. The volt seconds balance timing on inductor L1 is the same as on transformer 206, but inverted. Thus, induced current through and corresponding voltage across auxiliary winding P2 is suitably timed for the turn on and off of switch Q2. Unlike some known systems, no additional control chip is needed to provide on/off timing control of Q2. The clamp voltage automatically adjusts along with operation of the flyback converter from no load to full power. If the clamp voltage is too high, converter 212 simply transfers more energy to input capacitor 202 until the voltage drops to just above the flyback voltage.

Power converters in accordance with this disclosure have reduced losses due to leakage inductance and accordingly higher efficiencies. Leakage energy which is lost and dissipated as heat in some known converters is instead recycled and returned to the input of the converter. Power converters in accordance with this disclosure may have lower losses, reduced voltage stress on components, lower operating temperature, and higher circuit reliability due to the lower stresses as compared to some known converters. Moreover, in some embodiments, the leakage energy recovery circuit does not use any separate control signals to operate, but rather naturally tracks operation of the flyback converter when the converter is operated in quasi-resonant or boundary conduction mode.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A power converter assembly comprising:
an input for receiving a direct current (DC) power input;
a flyback converter coupled to the input, the flyback converter including a transformer having a plurality of windings; and
a leakage energy recovery circuit coupled to the flyback converter, the leakage energy recovery circuit configured to couple leakage energy from the transformer to the input in response to a voltage across at least one of the plurality of windings

2. The power converter assembly of claim 1, wherein the leakage energy recovery circuit comprises:
a power converter circuit coupled to the transformer and the input, the power converter circuit configured to selectively couple leakage energy to the input in response to the voltage across the at least one of the plurality of windings.

3. The power converter assembly of claim 2, wherein the leakage energy recovery circuit comprises:
a clamp circuit coupled to the transformer and configured to store leakage energy from the transformer; and
wherein the power converter circuit is configured to couple leakage energy from the clamp circuit to the input in response to the voltage across the at least one of the plurality of windings.

4. The power converter assembly of claim 3, wherein the transformer comprises:
a primary winding;
a secondary winding; and
an auxiliary winding, and wherein the power converter circuit is configured to couple leakage energy from the clamp circuit to the input in response to the voltage across the auxiliary winding.

5. The power converter assembly of claim 4, wherein the power converter circuit comprises a buck converter.

6. The power converter assembly of claim 4, wherein an input of the power converter circuit is coupled to the clamp circuit, and an output of the power converter circuit is coupled to the power converter assembly input.

7. The power converter assembly of claim 6, wherein the power converter circuit comprises a switch coupled between the power converter circuit input and the power converter circuit output, and the switch is controlled by the voltage across the auxiliary winding.

8. The power converter assembly of claim 1, wherein the flyback converter is configured to operate in a boundary conduction mode.

9. The power converter assembly of claim 1, wherein the flyback converter is a quasi-resonant flyback converter.

10. The power converter assembly of claim 1, wherein the flyback converter comprises an output for providing a substantially DC power output, and the assembly further comprises a DC to alternating current (AC) converter having an input coupled to the flyback converter output.

11. A photovoltaic (PV) power system comprising:
a first converter configured to receive a direct current (DC) power input and provide a substantially DC power output, the first converter comprising:
an input for receiving the DC power input;
a flyback converter coupled to the input, the flyback converter including a transformer having a primary winding, a secondary winding, and an auxiliary winding; and
a leakage energy recovery circuit comprising:
a clamp circuit coupled to the primary winding of the transformer and configured to store leakage energy from the transformer; and
an auxiliary converter coupled to the auxiliary winding, the clamp circuit, and the input, auxiliary converter configured to couple leakage energy from the clamp circuit to the input in response to a voltage across the auxiliary winding.

12. The PV power system of claim 11, wherein the auxiliary converter comprises a buck converter.

13. The PV power system of claim 12, wherein an input of the buck converter is coupled to the clamp circuit, and an output of the buck converter is coupled to the first converter input.

14. The PV power system of claim 13, wherein the buck converter comprises a switch coupled between the buck converter input and the buck converter output, and the switch is controlled by the voltage across the auxiliary winding.

15. The PV power system of claim 11, wherein the flyback converter is configured to operate in a boundary conduction mode.

16. The PV power system of claim 11, wherein the flyback converter is a quasi-resonant flyback converter.

17. The PV power system of claim 11, further comprising a second converter configured to receive a DC power input from the first converter and provide an alternating current power output.

18. The PV power system of claim 17, further comprising at least one PV module coupled to the first converter input to provide the DC power input.

19. A method of recovering transformer leakage energy in a power converter, the method comprising:
storing transformer leakage energy in a clamp circuit;
selectively coupling the stored transformer leakage energy to an input of the power converter based on a voltage across an auxiliary winding of the transformer.

20. The method of claim 19, wherein the stored transformer leakage energy is selectively coupled to the input of the power converter by a buck converter.
